(19) United States
(12) Patent Application Publication
(10) Pub. No.: US 2024/0219246 A1
(43) Pub. Date: Jul. 4, 2024

(54) LOAD SENSOR

(71) Applicant: Panasonic Intellectual Property Management Co., Ltd., Osaka (JP)

(72) Inventors: Susumu URAGAMI, Kumamoto (JP); Takafumi HAMANO, Fukuoka (JP); Yuta MORIURA, Osaka (JP); Takashi MATSUMOTO, Osaka (JP); Hironobu UKITSU, Osaka (JP); Yodai MATSUMURA, Osaka (JP)

(21) Appl. No.: 18/601,767

(22) Filed: Mar. 11, 2024

Related U.S. Application Data
(63) Continuation of application No. PCT/JP2022/014171, filed on Mar. 24, 2022.

(30) Foreign Application Priority Data
Sep. 22, 2021 (JP) 2021-154674

(51) Int. Cl. G01L 1/14

(52) U.S. Cl. CPC G01L 1/146

(57) ABSTRACT

A load sensor includes: a base member having a flat plate shape; a plurality of electrically-conductive elastic bodies disposed so as to extend in a first direction on an upper face of the base member; at least one electrically-conductive member extending in a second direction and crossing the plurality of the electrically-conductive elastic bodies; a dielectric body disposed between the plurality of electrically-conductive elastic bodies and the electrically-conductive member; and a plurality of wires respectively connected to the plurality of electrically-conductive elastic bodies and disposed so as to extend in the second direction on the upper face of the base member. Each wire is disposed at a position where the wire does not overlap with the electrically-conductive member, and is insulated at least in a range where the wire overlaps with the electrically-conductive elastic body other than the electrically-conductive elastic body serving as a connection target.

### CROSS REFERENCE TO RELATED APPLICATION

This application is a continuation of International Application No. PCT/JP2022/014171 filed on Mar. 24, 2022, entitled “LOAD SENSOR”, which claims priority under 35 U.S.C. Section 119 of Japanese Patent Application No. 2021-154674 filed on Sep. 22, 2021, entitled “LOAD SENSOR”. The disclosures of the above applications are incorporated herein by reference.

### BACKGROUND OF THE INVENTION

### Field of the Invention

The present invention relates to a load sensor which detects a load applied from outside, based on change in capacitance.

### Description of Related Art

Load sensors are widely used in the fields of industrial apparatuses, robots, vehicles, and the like. In recent years, in accordance with advancement of control technologies by computers and improvement of design, development of electronic apparatuses that use a variety of free-form surfaces such as those in human-form robots and interior equipment of automobiles is in progress. In association therewith, it is required to mount a high performance load sensor to each free-form surface.

International Publication No. WO2020/079995 describes a pressure-sensitive element (load sensor) including: a plurality of first electrodes each implemented by an elastic body that is electrically conductive; a plurality of second electrodes each implemented by an electrically-conductive member having a linear shape; and a dielectric body covering the surface of each second electrode. The plurality of first electrodes and the plurality of second electrodes are disposed so as to cross each other in a plan view.

In this configuration, when a load applied to each crossing position between a first electrode and a corresponding second electrode increases, the contact area between the first electrode and the dielectric body increases at the crossing position. In association therewith, the capacitance between the first electrode and the second electrode increases. Therefore, by detecting the value of the capacitance between the first electrode and the second electrode for each crossing position, it is possible to detect the load applied to the crossing position.

In the above configuration, a connector electrically connected to the plurality of first electrodes and a connector electrically connected to the plurality of second electrodes are individually disposed at positions different from each other. The connector connected to the first electrodes is disposed in the direction in which the first electrodes extend, and the connector connected to the second electrodes is disposed in the direction in which the second electrodes extend. Accordingly, the size of the load sensor becomes large, and the outer peripheral portion where the connectors are disposed becomes a dead zone where loads cannot be detected.

### SUMMARY OF THE INVENTION

A main aspect of the present invention relates to a load sensor. A load sensor according to the present aspect includes: a base member having a flat plate shape; a plurality of electrically-conductive elastic bodies disposed so as to extend in a first direction on an upper face of the base member; at least one electrically-conductive member extending in a second direction and crossing the plurality of electrically-conductive elastic bodies; a dielectric body disposed between the plurality of electrically-conductive elastic bodies and the electrically-conductive member; and a plurality of wires respectively connected to the plurality of electrically-conductive elastic bodies and disposed so as to extend in the second direction on the upper face of the base member. Each wire is disposed at a position where the wire does not overlap with the electrically-conductive member, and is insulated at least in a range where the wire overlaps with the electrically-conductive elastic body other than the electrically-conductive elastic body serving as a connection target.

In the load sensor according to the present aspect, the electrically-conductive member and the wire extend in the same direction. Therefore, one end portion of the electrically-conductive member and an end portion of the wire can be disposed in the same region. Therefore, as compared with a case where these regions are provided in different places, the size of the load sensor can be reduced, and the dead zone that is caused in the outer peripheral portion can be reduced.

The effects and the significance of the present invention will be further clarified by the description of the embodiments below. However, the embodiments below are merely examples for implementing the present invention. The present invention is not limited to the description of the embodiments below in any way.

### BRIEF DESCRIPTION OF THE DRAWINGS

FIG. 1A is a perspective view schematically showing the structure of an upper face of a base member on the lower side, according to Embodiment 1;

FIG. 1B is a perspective view schematically showing a state where conductor wires are set on the base member on the lower side, according to Embodiment 1;

FIG. 2A is a perspective view showing a state where a circuit board is set on the structure in FIG. 1B, according to Embodiment 1;

FIG. 2B is a perspective view showing a state where a base member on the upper side is set on the structure in FIG. 2A, according to Embodiment 1;

FIG. 3A and FIG. 3B are each a cross-sectional view schematically showing the surrounding of the conductor wire when viewed in the X-axis negative direction, according to Embodiment 1;

FIG. 4A to FIG. 4D show steps of forming electrically-conductive elastic bodies, wires, insulators, and electric conductors, on the upper face of the base member, according to Embodiment 1;

FIG. 5A is a plan view schematically showing a see-through state where the inside of the load sensor is viewed from above, according to Embodiment 1;

FIG. 5B is a plan view schematically showing a see-through state where the inside of a load sensor is viewed from above, according to Comparative Example;

FIG. 6 shows a state where a plurality of the load sensors are disposed so as to be arranged in the Y-axis direction, according to Embodiment 1;

FIG. 7A is a perspective view showing the configuration of a structure according to Embodiment 2;

FIG. 7B is a perspective view showing the structure of the lower face of the base member on the upper side, according to Embodiment 2;

FIG. 8 shows a state where the base member on the upper side is superposed on the upper face of the base member on the lower side, according to Embodiment 2;

FIG. 9A and FIG. 9B are each a cross-sectional view schematically showing the surrounding of the conductor wire of the load sensor, according to Embodiment 2;

FIG. 10A is a perspective view showing the configuration of a structure according to Embodiment 3;

FIG. 10B is a perspective view showing the structure of the lower face of the base member on the upper side, according to Embodiment 3;

FIG. 11A is a perspective view showing a state where the structure in FIG. 10B is superposed, upside down, on the structure in FIG. 10A, according to Embodiment 3;

FIG. 11B is an enlarged side view showing end portions of electric conductors opposing each other, according to Embodiment 3;

FIG. 11C is a side view showing a state where, from the state in FIG. 11B, the peripheries of the electric conductors opposing each other are sewn by a thread; and

FIG. 12A and FIG. 12B are each a cross-sectional view schematically showing the surrounding of a electrically-conductive member when viewed in the X-axis negative direction, according to a modification.

It is noted that the drawings are solely for description and do not limit the scope of the present invention in any way.

### DETAILED DESCRIPTION

The load sensor according to the present invention is applicable to a load sensor of a management system or an electronic apparatus that performs processing in accordance with an applied load.

Examples of the management system include a stock management system, a driver monitoring system, a coaching management system, a security management system, and a caregiving/nursing management system.

In the stock management system, for example, by a load sensor provided to a stock shelf, the load of a placed stock is detected, and the kinds of commodities and the number of commodities present on the stock shelf are detected. Accordingly, in a store, a factory, a warehouse, and the like, the stock can be efficiently managed, and manpower saving can be realized. In addition, by a load sensor provided in a refrigerator, the load of food in the refrigerator is detected, and the kinds of the food and the quantity and amount of the food in the refrigerator are detected. Accordingly, a menu that uses food in a refrigerator can be automatically proposed.

In the driver monitoring system, by a load sensor provided to a steering device, the distribution of a load (e.g., gripping force, grip position, tread force) applied to the steering device by a driver is monitored, for example. In addition, by a load sensor provided to a vehicle-mounted seat, the distribution of a load (e.g., the position of the center of gravity) applied to the vehicle-mounted seat by the driver in a seated state is monitored. Accordingly, the driving state (sleepiness, mental state, and the like) of the driver can be fed back.

In the coaching management system, for example, by a load sensor provided to the bottom of a shoe, the load distribution at a sole is monitored. Accordingly, correction or guidance to an appropriate walking state or running state can be realized.

In the security management system, for example, by a load sensor provided to a floor, the load distribution is detected when a person passes, and the body weight, stride, passing speed, shoe sole pattern, and the like are detected. Accordingly, the person who has passed can be identified by checking these pieces of detection information against data.

In the caregiving/nursing management system, for example, by load sensors provided to bedclothes and a toilet seat, the distributions of loads applied by a human body to the bedclothes and the toilet seat are monitored. Accordingly, at the positions of the bedclothes and the toilet seat, what action the person is going to take is estimated, whereby tumbling or falling can be prevented.

Examples of the electronic apparatus include a vehicle-mounted apparatus (car navigation system, audio apparatus, etc.), a household electrical appliance (electric pot, IH cooking heater, etc.), a smartphone, an electronic paper, an electronic book reader, a PC keyboard, a game controller, a smartwatch, a wireless earphone, a touch panel, an electronic pen, a penlight, lighting clothes, and a musical instrument. In an electronic apparatus, a load sensor is provided to an input part that receives an input from a user.

The load sensor in the embodiments below is a capacitance-type load sensor that is typically provided in a load sensor of a management system or an electronic apparatus as described above. Such a load sensor may be referred to as a “capacitance-type pressure-sensitive sensor element”, a “capacitive pressure detection sensor element”, a “pressure-sensitive switch element”, or the like. The load sensor in the embodiments below is connected to a detection circuit, and the load sensor and the detection circuit form a load detection device. The embodiments below are some examples of embodiments of the present invention, and the present invention is not limited to the embodiments below in any way.

Hereinafter, embodiments of the present invention will be described with reference to the drawings. For convenience, X-, Y-, and Z-axes orthogonal to each other are indicated in the drawings. The Z-axis direction is the height direction of a load sensor 1.

### Embodiment 1

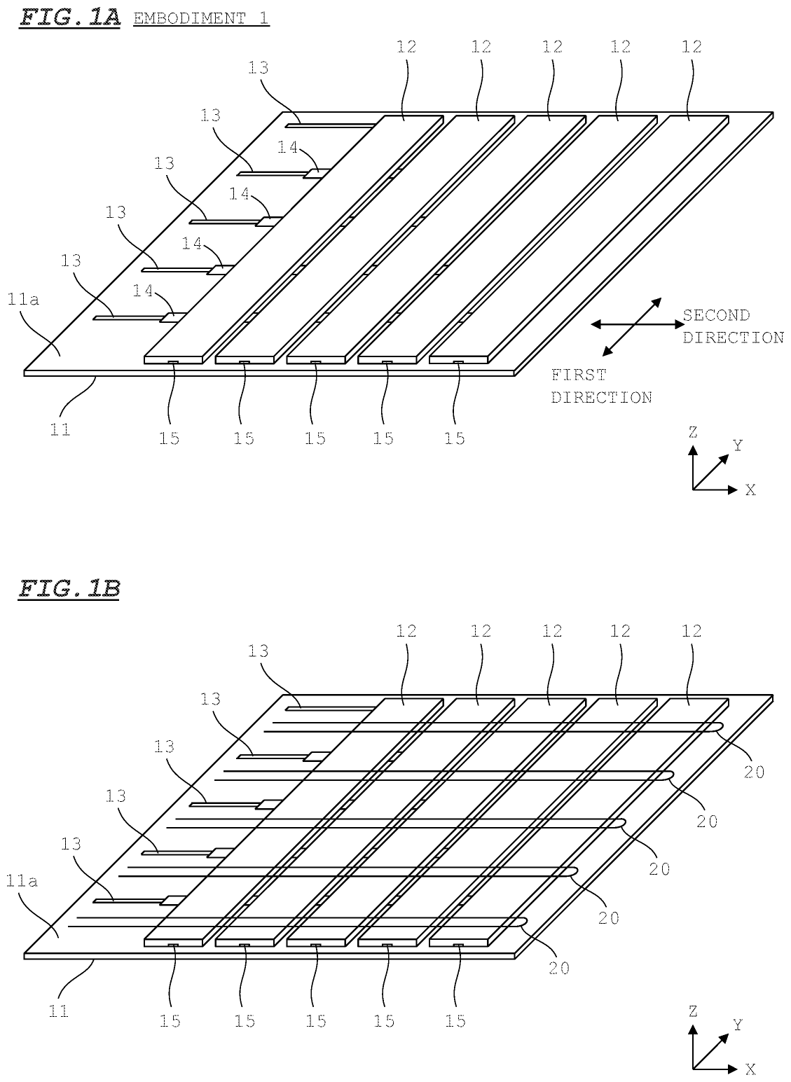

FIG. 1A is a perspective view schematically showing a base member 11, electrically-conductive elastic bodies 12 set on an upper face 11a (the face on the Z-axis positive side) of the base member 11, wires 13, insulators 14, and electric conductors 15.

The base member 11 is an insulative flat-plate-shaped member having elasticity. The base member 11 has a rectangular shape in a plan view. The thickness of the base member 11 is constant. When the thickness of the base member 11 is small, the base member 11 maybe referred to as a sheet member or a film member. The base member 11 is formed from a non-electrically-conductive resin material or a non-electrically-conductive rubber material.

The resin material used in the base member 11 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example. The rubber material used in the base member 11 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electrically-conductive elastic bodies 12 are disposed on the upper face 11a (the face on the Z-axis positive side) of the base member 11. In FIG. 1A, five electrically-conductive elastic bodies 12 are disposed on the upper face 11a of the base member 11. Each electrically-conductive elastic body 12 is a member that is electrically conductive and that has elasticity. Each electrically-conductive elastic body 12 has a band-like shape that is long in the Y-axis direction. Each electrically-conductive elastic body 12 is disposed so as to extend in a first direction (the Y-axis direction). That is, the long sides of the electrically-conductive elastic body 12 is parallel to the Y-axis. The widths, the lengths, and the thicknesses of the five electrically-conductive elastic bodies 12 are the same with each other. A predetermined gap is provided between adjacent electrically-conductive elastic bodies 12.

Each electrically-conductive elastic body 12 is formed on the upper face 11a of the base member 11 by a printing method such as screen printing, gravure printing, flexographic printing, offset printing, or gravure offset printing. With these printing methods, the electrically-conductive elastic body 12 can be formed so as to have a thickness of about 0.001 mm to 0.5 mm on the upper face 11a of the base member 11. However, the forming method for the electrically-conductive elastic body 12 is not limited to the printing method.

Each electrically-conductive elastic body 12 is formed from a resin material and an electrically-conductive filler dispersed therein, or from a rubber material and an electrically-conductive filler dispersed therein.

Similar to the resin material used in the base member 11 described above, the resin material used in the electrically-conductive elastic body 12 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example. Similar to the rubber material used in the base member 11 described above, the rubber material used in the electrically-conductive elastic body 12 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electrically-conductive filler used in the electrically-conductive elastic body 12 is a material of at least one type selected from the group consisting of: metal materials such as Au (gold), Ag (silver), Cu (copper), C (carbon), ZnO (zinc oxide), In₂O₃ (indium oxide (III)), and SnO₂ (tin oxide (IV)); electrically-conductive macromolecule materials such as PEDOT: PSS (i.e., a complex composed of poly(3,4-ethylenedioxythiophene) (PEDOT) and polystyrene sulfonate (PSS)); and electrically-conductive fibers such as a metal-coated organic matter fiber and a metal wire (fiber state), for example. In Embodiment 1, the electrically-conductive filler forming the electrically-conductive elastic body 12 is C (carbon).

The wires 13 are disposed on the upper face 11a of the base member 11. The number of the wires 13 is the same as the number of the electrically-conductive elastic bodies 12. In FIG. 1A, five wires 13 are disposed on the upper face 11a of the base member 11. Each wire 13 is disposed so as to extend in a second direction (the X-axis direction).

The five wires 13 are respectively connected to the five electrically-conductive elastic bodies 12. The five wires 13 and the five electrically-conductive elastic bodies 12 are connected in a one-to-one relationship. Here, the wire 13 on the most Y-axis positive side is connected to the electrically-conductive elastic body 12 on the most X-axis negative side. The wire 13 on the most Y-axis negative side is connected to the electrically-conductive elastic body 12 on the most X-axis positive side. The second, third, and fourth wires from the Y-axis positive side are respectively connected to the second, third, and fourth electrically-conductive elastic bodies 12 from the X-axis negative side.

Each wire 13 is formed from a resin material and an electrically-conductive filler dispersed therein, or from a rubber material and an electrically-conductive filler dispersed therein. As the resin material or the rubber material forming the wire 13, materials similar to those for the electrically-conductive elastic body 12 can be used. As the electrically-conductive filler forming the wire 13, a material having excellent electric conductivity, out of the above materials shown as examples of the electrically-conductive filler for the electrically-conductive elastic body 12, can be used. In Embodiment 1, the electrically-conductive filler forming the wire 13 is Ag (silver). The wire 13 is formed on the upper face 11a of the base member 11 by the printing method described above.

Each wire 13 is insulated in a range where the wire 13 overlaps with the electrically-conductive elastic bodies 12 other than the electrically-conductive elastic body 12 serving as a connection target. That is, out of the range of the wire 13 in the longitudinal direction, in a range where the wire 13 overlaps with the electrically-conductive elastic bodies 12 other than the electrically-conductive elastic body 12 serving as the connection target, the insulator 14 covering the wire 13 is formed. Thus, the insulator 14 is present between the wire 13 and the electrically-conductive elastic bodies 12 not serving as the connection target. Accordingly, the wire 13 is connected only to the electrically-conductive elastic body 12 serving as the connection target. The insulator 14 is formed from a polyurethane resin, for example. The insulator 14 is formed on the upper face 11a of the base member 11 by the printing method described above.

Each electric conductor 15 is disposed on the upper face 11a of the base member 11. Here, five electric conductors 15 are disposed on the upper face 11a of the base member 11 so as to be respectively covered by the five electrically-conductive elastic bodies 12 and so as to each extend in the first direction. The electric conductors 15 are disposed over a substantially entire range of the electrically-conductive elastic bodies 12 in the first direction. That is, the lengths of each electrically-conductive elastic body 12 and each electric conductor 15 in the Y-axis direction are substantially the same with each other. The electric conductor 15 is disposed at a substantially middle position of the electrically-conductive elastic body 12 in the X-axis direction.

The electric conductor 15 is formed from a material having a resistance lower than that of the electrically-conductive elastic body 12. In Embodiment 1, the electric conductor 15 is a member that is electrically conductive and that has elasticity. The electric conductor 15 is formed from a resin material and an electrically-conductive filler dispersed therein, or from a rubber material and an electrically-conductive filler dispersed therein. As the resin material or the rubber material forming the electric conductor 15, materials similar to those for the electrically-conductive elastic body 12 can be used. As the electrically-conductive filler forming the electric conductor 15, a material having excellent electric conductivity, out of the above materials shown as examples of the electrically-conductive filler for the electrically-conductive elastic body 12, can be used. In Embodiment 1, the electrically-conductive filler forming the electric conductor 15 is Ag (silver). The electric conductor 15 is formed on the upper face 11a of the base member 11 by the printing method described above.

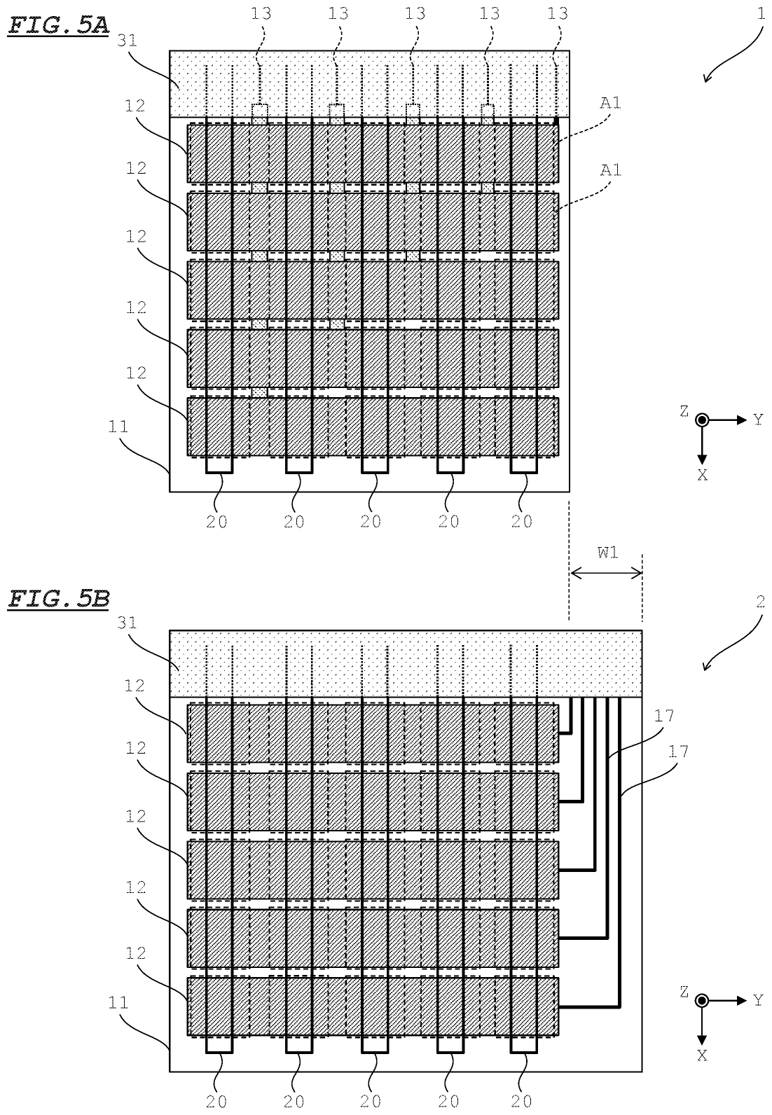

Each wire 13 is connected not only to the electrically-conductive elastic body 12 serving as the connection target but also to the electric conductor 15 that is disposed at the position of the electrically-conductive elastic body 12 serving as the connection target. Since each wire 13 is connected to the corresponding electric conductor 15 having a low resistance, the resistance value between each position in the Y-axis direction of the electrically-conductive elastic bodies 12 and an end portion on the X-axis negative side of the corresponding wire 13 can be decreased, as compared with a case where the electric conductors 15 are omitted. Accordingly, the detection sensitivity in a later-described sensor part A1 (see FIG. 5A) can be increased.

The width in the X-axis direction and the thickness in the Z-axis direction of the electric conductor 15 are much smaller than those of the electrically-conductive elastic body 12. The thickness of the electric conductor 15 is about several microns. Therefore, the elastic property of the electric conductor 15 does not have a large influence on the elastic property of the electrically-conductive elastic body 12, and even when the electric conductor 15 containing an electrically-conductive filler more expensive than that of the electrically-conductive elastic body 12 is disposed, large increase in cost is not caused.

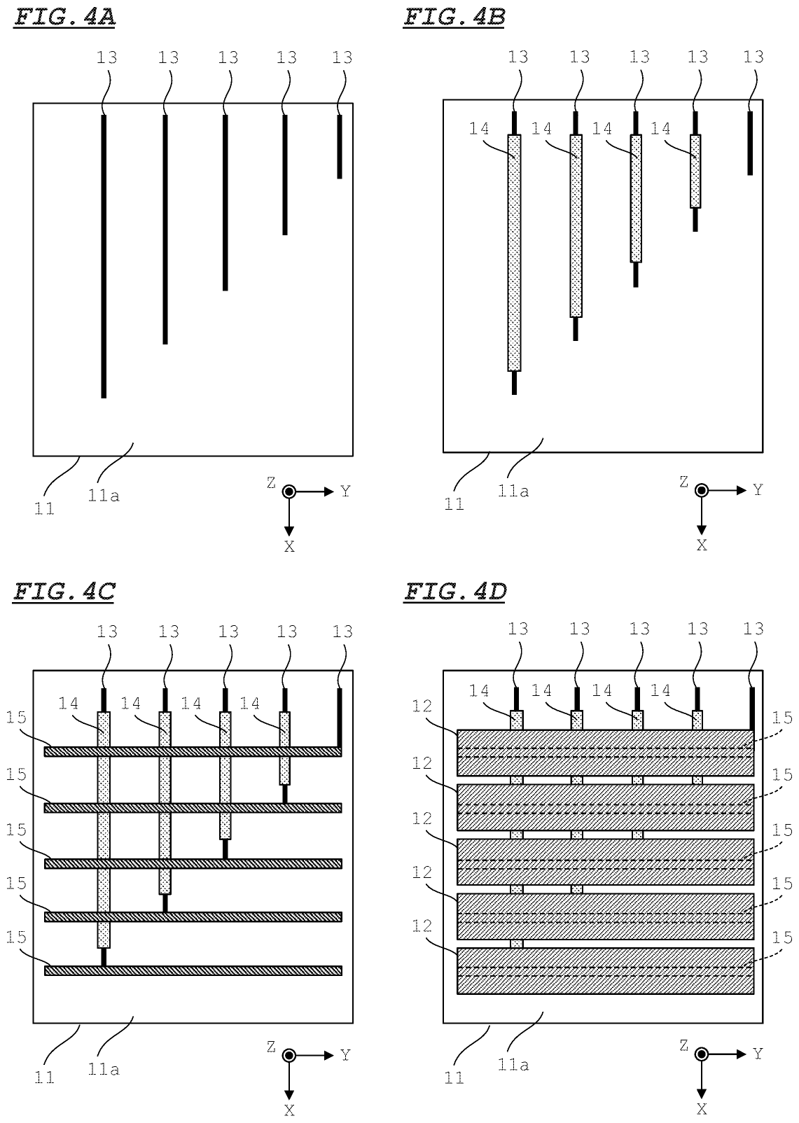

In FIG. 1A, for convenience, the thicknesses of the electrically-conductive elastic body 12 and the electric conductor 15 are shown to be large. However, in actuality, the thickness of the electrically-conductive elastic body 12 is about several hundred microns at most, and the thickness of the electric conductor 15 is about several microns. A forming method for the structure in FIG. 1A will be described later with reference to FIGS. 4A to 4D.

FIG. 1B is a perspective view schematically showing a state where conductor wires 20 are set on the base member 11.

Each conductor wire 20 is formed by a linear-shaped member being bent at a middle position. In Embodiment 1, five conductor wires 20 are disposed so as to extend in the second direction (the X-axis direction). The five conductor wires 20 are disposed so as to be superposed on the upper faces of the electrically-conductive elastic bodies 12 such that the five conductor wires 20 each cross the five electrically-conductive elastic bodies 12.

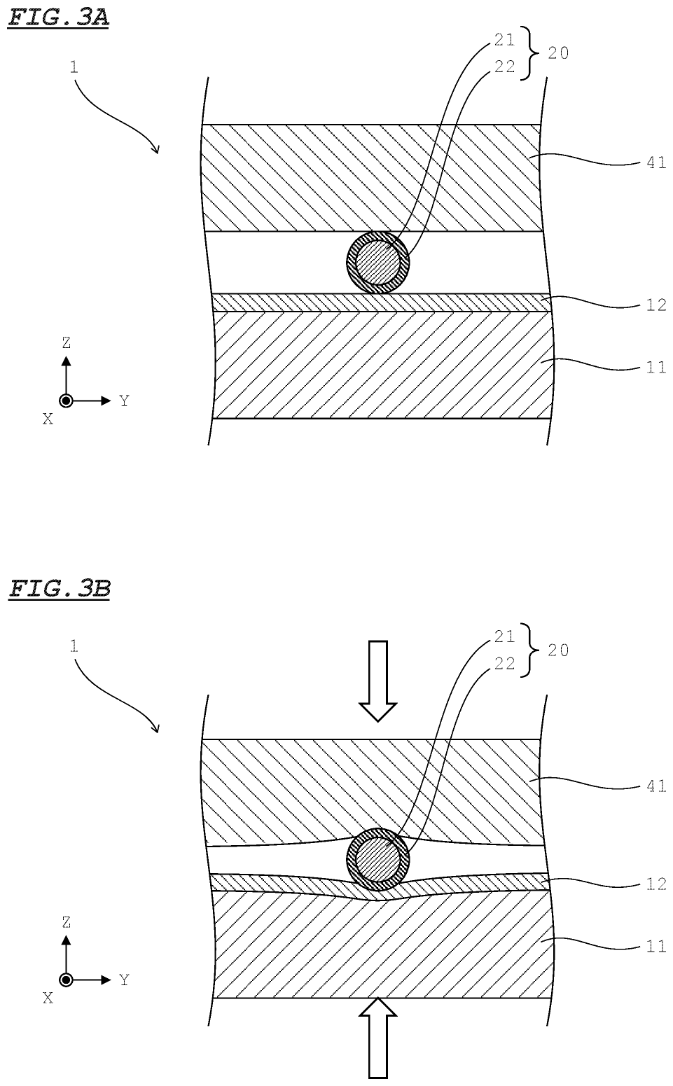

In a plan view, four conductor wires 20 are each disposed between adjacent wires 13. In other words, in a range between adjacent conductor wires 20, a wire 13 is disposed. In a plan view, the wires 13 and the conductor wires 20 are disposed at positions where the wires 13 and the conductor wires 20 do not overlap each other. Here, at a middle position between adjacent wires 13, a conductor wire 20 is disposed. In other words, at a middle position between adjacent conductor wires 20, a wire 13 is disposed. As described later, each conductor wire 20 is composed of an electrically-conductive member 21 having a linear shape and a dielectric body 22 formed so as to cover the surface of the electrically-conductive member 21 (see FIGS. 3A, 3B).

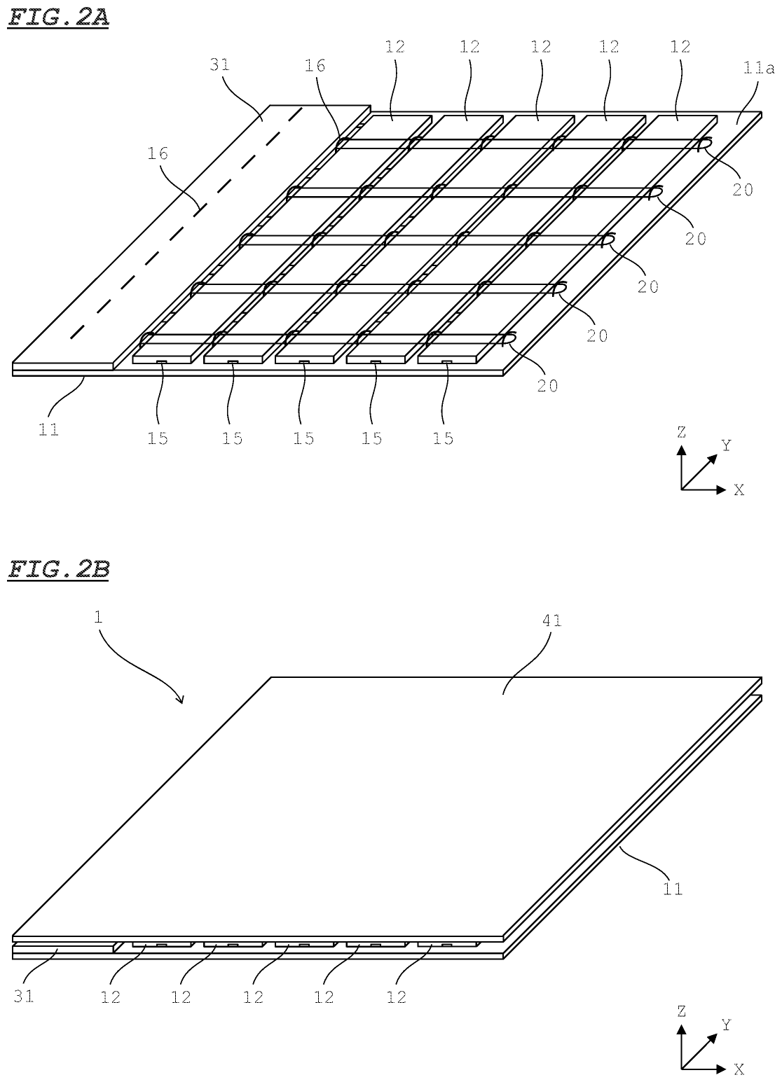

FIG. 2A is a perspective view showing a state where a circuit board 31 is set on the structure in FIG. 1B.

The circuit board 31 is disposed on the upper face 11a of the base member 11 so as to be arranged on the X-axis negative side of the electrically-conductive elastic bodies 12. The circuit board 31 is disposed so as to cover end portions on the X-axis negative side of the five wires 13 and the five conductor wires 20. On the lower face (the face on the Z-axis negative side) of the circuit board 31, a plurality of electrodes are disposed at positions respectively overlapping with the end portions on the X-axis negative side of the five wires 13 and the five conductor wires 20. With respect to the conductor wires 20, in a range where the conductor wires 20 overlap with the electrodes on the circuit board 31 side, the covering dielectric body 22 is omitted, and the electrically-conductive member 21 is exposed. The five conductor wires 20 are connected with solder to the corresponding electrodes at the time of setting of the circuit board 31.

When the circuit board 31 is set on the upper face 11a of the base member 11, the five conductor wires 20 are set on the base member 11 by threads 16. In the example shown in FIG. 2A, 30 threads 16 are sewn to the base member 11 so as to extend across the conductor wires 20 at positions other than the positions where the electrically-conductive elastic bodies 12 and the conductor wires 20 overlap each other. As for the five conductor wires 20, movement in the longitudinal direction is restricted by being sewn at the U-shaped bent portion. The other portions of the five conductor wires 20 are loosely sewn by the threads 16 so as to be moveable in the longitudinal direction. Each thread 16 is implemented by a chemical fiber, a natural fiber, a mixed fiber of the chemical fiber and the natural fiber, or the like.

The circuit board 31 is sewn to the base member 11 by the threads 16. At this time, the threads 16 are tightly sewn such that the end portions on the X-axis negative side of the wires 13 and the electrodes on the lower face of the circuit board 31 overlapping with these end portions are joined. Accordingly, the end portions of the wires 13 and the electrodes are pressed against each other, whereby the wires 13 are electrically connected to the circuit board 31.

FIG. 2B is a perspective view showing a state where a base member 41 is set on the structure in FIG. 2A.

The base member 41 has a configuration similar to that of the base member 11. The base member 41 has the same size and shape as those of the base member 11, and is formed from the same material as that of the base member 11. The base member 41 is disposed on the upper face of the structure in FIG. 2A. Then, the outer peripheral portion of the base member 41 is connected to the outer peripheral portion of the base member 11 with a silicone rubber-based adhesive, a thread, or the like. Accordingly, the base member 41 is fixed to the base member 11. Accordingly, the load sensor 1 is completed.

The load sensor 1 maybe used upside down from the state in FIG. 2. In this case, the base member 41 need not necessarily be formed from a material similar to that of the base member 11, and may be formed from a hard material that is less likely to be elastically deformed, for example.

FIGS. 3A, 3B are each a cross-sectional view schematically showing the surrounding of the conductor wire 20 when the load sensor 1 in FIG. 2B is viewed in the X-axis negative direction. FIG. 3A shows a state where no load is applied, and FIG. 3B shows a state where loads are applied.

As shown in FIGS. 3A, 3B, the conductor wire 20 is composed of the electrically-conductive member 21 and the dielectric body 22 formed so as to cover the surface of the electrically-conductive member 21. The electrically-conductive member 21 is an electrically-conductive wire member.

The electrically-conductive member 21 is formed from an electrically-conductive metal material, for example. Other than this, the electrically-conductive member 21 maybe composed of a core wire made of glass, and an electrically-conductive layer formed on the surface of the core wire. Alternatively, the electrically-conductive member 21 maybe composed of a core wire made of resin, and an electrically-conductive layer formed on the surface of the core wire, for example. The electrically-conductive member 21 maybe a twisted wire obtained by twisting wire members made of an electrically-conductive metal material. In Embodiment 1, the electrically-conductive member 21 is formed from copper. The dielectric body 22 has an electric insulation property, and is formed from a resin material, a ceramic material, a metal oxide material, or the like, for example.

Other than this, as the electrically-conductive member 21, a valve action metal such as titanium (Ti), tantalum (Ta), niobium (Nb), zirconium (Zr), or hafnium (Hf); tungsten (W); molybdenum (Mo); aluminum (Al); nickel (Ni); silver (Ag); gold (Au); or the like is used. The diameter of the electrically-conductive member 21 maybe not less than 10 μm and not greater than 1500 μm, and may be not less than 50 μm and not greater than 800 μm, for example. Such a configuration of the electrically-conductive member 21 is preferable from the viewpoint of the resistance and the strength of the electrically-conductive member 21. The thickness of the dielectric body 22 is preferably not less than 5 nm and not greater than 100 μm, and can be selected as appropriate according to the design of the sensitivity of the sensor and the like.

As shown in FIG. 3A, when no load is applied to the load sensor 1, the force applied between the electrically-conductive elastic body 12 and the conductor wire 20 is substantially zero. From this state, as shown in FIG. 3B, when a load is applied in the upward direction to the lower face of the base member 11, and a load is applied in the downward direction to the upper face of the base member 41, the electrically-conductive elastic body 12 is deformed by the conductor wire 20.

At this time, the conductor wire 20 is brought close to the electrically-conductive elastic body 12 so as to be wrapped by the electrically-conductive elastic body 12, and the contact area between the conductor wire 20 and the electrically-conductive elastic body 12 increases. Accordingly, the capacitance between the electrically-conductive member 21 and electrically-conductive elastic body 12 changes. This change in the capacitance is detected, whereby the load is calculated.

FIGS. 4A to 4D show steps of forming the electrically-conductive elastic bodies 12, the wires 13, the insulators 14, and the electric conductors 15 on the upper face 11a of the base member 11.

As described above, the electrically-conductive elastic bodies 12, the wires 13, the insulators 14, and the electric conductors 15 are formed by the printing method.

First, as shown in FIG. 4A, the five wires 13 are formed so as to extend in the X-axis direction on the upper face 11a of the base member 11. The ends on the X-axis negative side of the five wires 13 are at the same position in the X-axis direction. The length of each wire 13 is set to be a length with which the end on the X-axis positive side of the wire 13 reaches the position of the corresponding electric conductor 15.

Next, as shown in FIG. 4B, four insulators 14 are formed on the upper face 11a of the base member 11 so as to cover four wires 13 on the Y-axis negative side. Each insulator 14 is formed in a range excluding both end portions of the corresponding wire 13. Further, as shown in FIG. 4C, the five electric conductors 15 are formed so as to extend in the Y-axis direction. Each electric conductor 15 overlaps with an end portion, of the corresponding wire 13, where the insulator 14 is not formed. The lengths of the five electric conductors 15 are the same with each other. The positions of both ends of the five electric conductors 15 are the same in the Y-axis direction. The five electric conductors 15 are formed at an identical pitch in the X-axis direction.

The five electrically-conductive elastic bodies 12 are formed on the upper face 11a of the base member 11 so as to respectively cover the five electric conductors 15. The widths in the X-axis direction of the five electrically-conductive elastic bodies 12 are the same with each other, and the lengths in the Y-axis direction of the five electrically-conductive elastic bodies 12 are the same with each other. The length in the Y-axis direction of each electrically-conductive elastic body 12 is substantially the same as the length in the Y-axis direction of each electric conductor 15. The electric conductor 15 is disposed at a middle position in the x-axis direction of the electrically-conductive elastic body 12. A gap is provided between adjacent electrically-conductive elastic bodies 12.

In the configuration in FIG. 4D, the end portion on the X-axis positive side of each wire 13 is joined to the electrically-conductive elastic body 12 and the electric conductor 15 that are the connection target. The insulator 14 is formed in the range, of each wire 13, where the wire 13 overlaps with the electrically-conductive elastic bodies 12 and the electric conductors 15 other than the electrically-conductive elastic body 12 and the electric conductor 15 that are the connection target. Accordingly, each wire 13 is connected only to the electrically-conductive elastic body 12 and the electric conductor 15 that are the connection target.

FIG. 5A is a plan view schematically showing a see-through state where the inside of the load sensor 1 viewed from above. In FIG. 5A, the threads 16 are not shown, for convenience.

In the load sensor 1, 25 sensor parts A1 arranged in the X-axis direction and the Y-axis direction are set. That is, rectangular regions where the electrically-conductive elastic bodies 12 and the conductor wires 20 cross each other are set to be the sensor parts A1 where loads can be detected. Each wire 13 is disposed at a position between the sensor parts A1 adjacent to each other in the Y-axis direction.

FIG. 5B is a plan view schematically showing a see-through state of the inside of a load sensor 2 according to Comparative Example, viewed from above.

In Comparative Example, wires 17 each connecting a corresponding electrically-conductive elastic body 12 and the circuit board 31 are drawn to the Y-axis positive side of the electrically-conductive elastic body 12. Therefore, the base member 11 is provided with a region for forming the wires 17 in an end portion on the Y-axis positive side, and as compared with the configuration of Embodiment 1 in FIG. 5A, has a size increased in the Y-axis direction by a width W1 of this region. In Comparative Example, the region corresponding to the width W1 results in a dead zone where loads cannot be detected.

In contrast to this, in the configuration of Embodiment 1, the region where the wires 17 are disposed is omitted. Therefore, the size in the Y-axis direction can be reduced, and the dead zone that is caused in the outer peripheral portion of the load sensor 1 can be reduced.

In the configuration of Comparative Example, if the size of the load sensor 2 in the Y-axis direction is attempted to be reduced, the width W1 needs to be made as small as possible. In this case, in accordance with reduction in the width W1, the width of the wire 17 needs to be reduced. However, when the width of the wire 17 is reduced, the resistance value of the wire 17 increases. Therefore, the detection sensitivity of the load in each sensor part A1 decreases, and the load detection is more likely to be influenced by noise.

In contrast to this, in the configuration of Embodiment 1, each wire 13 is disposed in a range where the wire 13 does not overlap with the conductor wire 20, and thus, the width of the wire 13 can be set to be large. Accordingly, the resistance value of the wire 13 can be decreased. Therefore, the detection sensitivity of the load can be increased, and the load detection is less likely to be influenced by noise.

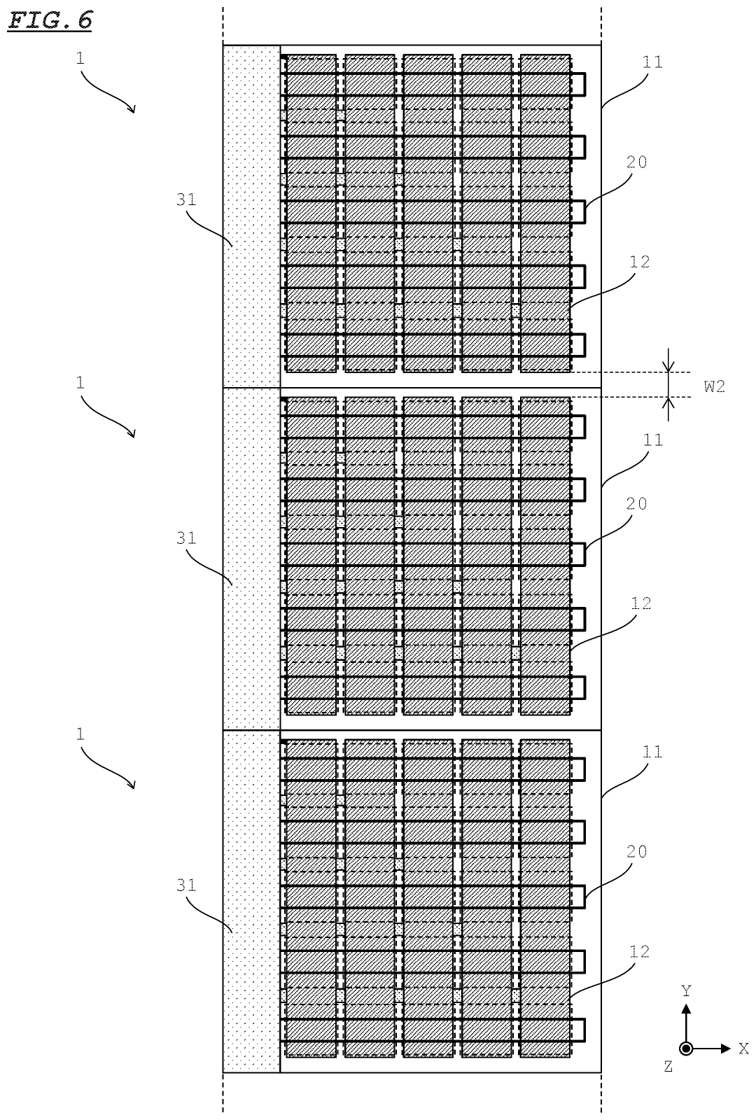

FIG. 6 shows a state where a plurality of the load sensors 1 are disposed so as to be arranged in the Y-axis direction. For convenience, in FIG. 6, the base members 41 are not shown.

As described with reference to FIGS. 5A, 5B, in the configuration of Embodiment 1, the size in the Y-axis direction of the load sensor 1 can be reduced. Therefore, when a plurality of the load sensors 1 are disposed so as to be arranged in the Y-axis direction as shown in FIG. 6, a width W2 of the dead zone where loads cannot be detected can be effectively reduced. Therefore, loads can be appropriately detected in a larger range.

### Effects of Embodiment 1

According to Embodiment 1, the following effects are exhibited.

As shown in FIG. 5A, since the conductor wire 20 (the electrically-conductive member 21) and the wire 13 extend in the same direction, one end portion of the conductor wire 20 (the electrically-conductive member 21) and an end portion of the wire 13 can be disposed in the same region. Therefore, as compared with a case where these regions are provided in different places as in Comparative Example in FIG. 5B, the size of the load sensor 1 can be reduced, and the dead zone that is caused in the outer peripheral portion of the load sensor 1 can be reduced.

As shown in FIGS. 4A to 4D, a plurality of the electric conductors 15 having a resistance lower than that of the electrically-conductive elastic bodies 12 are disposed on the upper face 11a of the base member 11 so as to be respectively covered by the plurality of the electrically-conductive elastic bodies 12 and so as to each extend in the first direction (the Y-axis direction). Each wire 13 is connected to the electric conductor 15 that is at the position of the electrically-conductive elastic body 12 serving as the connection target. Since each wire 13 is connected to the corresponding electric conductor 15 having a low resistance, the resistance value between each position in the Y-axis direction of the electrically-conductive elastic bodies 12 and an end portion on the X-axis negative side of the corresponding wire 13 can be decreased, as compared with a case where the electric conductors 15 are omitted. Accordingly, the detection sensitivity in the sensor part A1 can be increased.

The plurality of the electric conductors 15 are disposed over the entire range of the electrically-conductive elastic bodies 12 in the first direction (the Y-axis direction). Accordingly, over the entire length of each electrically-conductive elastic body 12, the resistance value of a combination structure of the electrically-conductive elastic body 12 and the electric conductor 15 can be decreased. Therefore, the detection sensitivity in all the sensor parts A1 set in the load sensor 1 can be increased.

As shown in FIG. 5A, in a range between the wires 13 adjacent to each other, the conductor wire 20 (the electrically-conductive member 21) is disposed. Accordingly, the wire 13 and the conductor wire 20 (the electrically-conductive member 21) can be smoothly disposed without being overlapped with each other. Since the interval between the wire 13 and the conductor wire 20 (the electrically-conductive member 21) can be widened, influence of the wire 13 on the load detection can be effectively suppressed.

As described with reference to FIGS. 4A to 4D, each electrically-conductive elastic body 12 and each wire 13 are formed on the upper face 11a of the base member 11 by printing. Accordingly, the electrically-conductive elastic body 12 and the wire 13 can be disposed on the upper face 11a of the base member 11 in a simple manner.

As shown in FIGS. 3A, 3B, the dielectric body 22 is set so as to cover the surface of the electrically-conductive member 21. With this configuration, by merely covering the surface of the electrically-conductive member 21 with the dielectric body 22, it is possible to dispose the dielectric body 22 between the electrically-conductive elastic body 12 and the electrically-conductive member 21.

### Embodiment 2

In Embodiment 1, no electrically-conductive elastic body is disposed on the base member 41. In contrast to this, in Embodiment 2, electrically-conductive elastic bodies are disposed also on the base member 41 in addition to the base member 11.

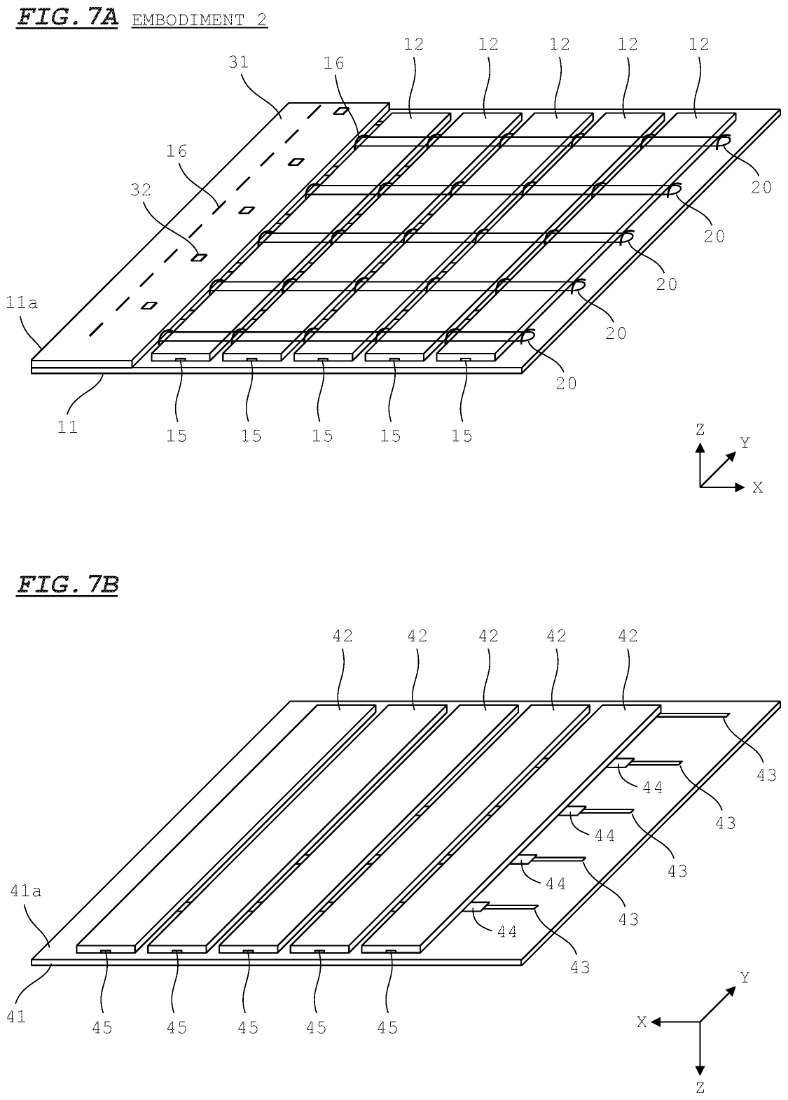

FIG. 7A is a perspective view showing the configuration of a structure according to Embodiment 2.

The structure in FIG. 7A corresponds to the structure in FIG. 2A. However, in the structure in FIG. 7A, five electrodes 32 are disposed so as to be arranged in the Y-axis direction on the upper face of the circuit board 31. The other configurations of the structure in FIG. 7A are similar to those of the structure in FIG. 2A.

FIG. 7B is a perspective view showing the structure of a lower face 41a of the base member 41, according to Embodiment 2.

Electrically-conductive elastic bodies 42, wires 43, insulators 44, and electric conductors 45 are disposed on the lower face 41a of the base member 41. The structure in FIG. 7B is a structure obtained by inverting the structure in FIG. 7A in the X-axis direction. The electrically-conductive elastic bodies 42, the wires 43, the insulators 44, and the electric conductors 45 are respectively formed from materials similar to those of the electrically-conductive elastic bodies 12, the wires 13, the insulators 14, and the electric conductors 15. The electrically-conductive elastic bodies 42, the wires 43, the insulators 44, and the electric conductors 45 are formed on the lower face 41a of the base member 41 by steps similar to those in FIGS. 4A to 4D.

The structure in FIG. 7B is superposed, upside down, on the upper face of the structure in FIG. 7A. Accordingly, five electrically-conductive elastic bodies 42 on the base member 41 side respectively oppose the five electrically-conductive elastic bodies 12 on the base member 11 side, and the five conductor wires 20 are sandwiched by the five electrically-conductive elastic bodies 42 and the five electrically-conductive elastic bodies 12. In addition, end portions on the X-axis negative side of five wires 43 on the base member 41 side respectively overlap the five electrodes 32 on the upper face of the circuit board 31.

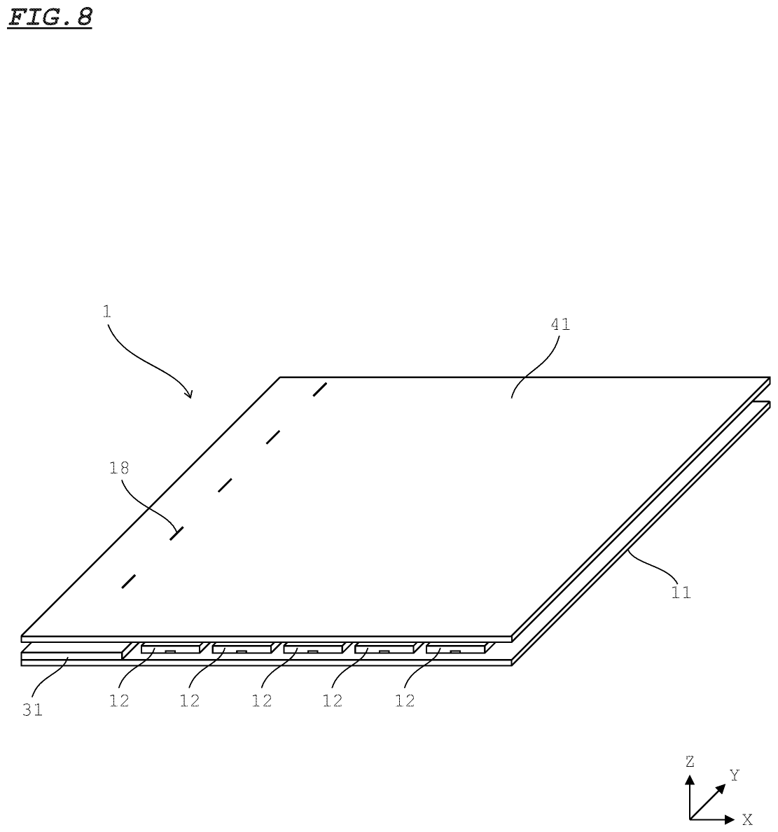

FIG. 8 shows a state where the base member 41 is superposed on the upper face of the base member 11.

In the state in FIG. 8, the base member 41 is sewn to the base member 11 by threads 18. At this time, the threads 18 are tightly sewn such that the end portions on the X-axis negative side of the wires 43 on the base member 41 side and the electrodes 32 on the upper face of the circuit board 31 overlapping with these end portions are in close contact with each other. Accordingly, the end portions of the wires 43 and the electrodes 32 are pressed against each other, whereby the wires 43 are electrically connected to the circuit board 31. Further, the outer peripheral portion of the base member 41 is connected to the outer peripheral portion of the base member 11 with a silicone rubber-based adhesive, a thread, or the like, whereby the base member 41 is fixed to the base member 11. Accordingly, the load sensor 1 is completed.

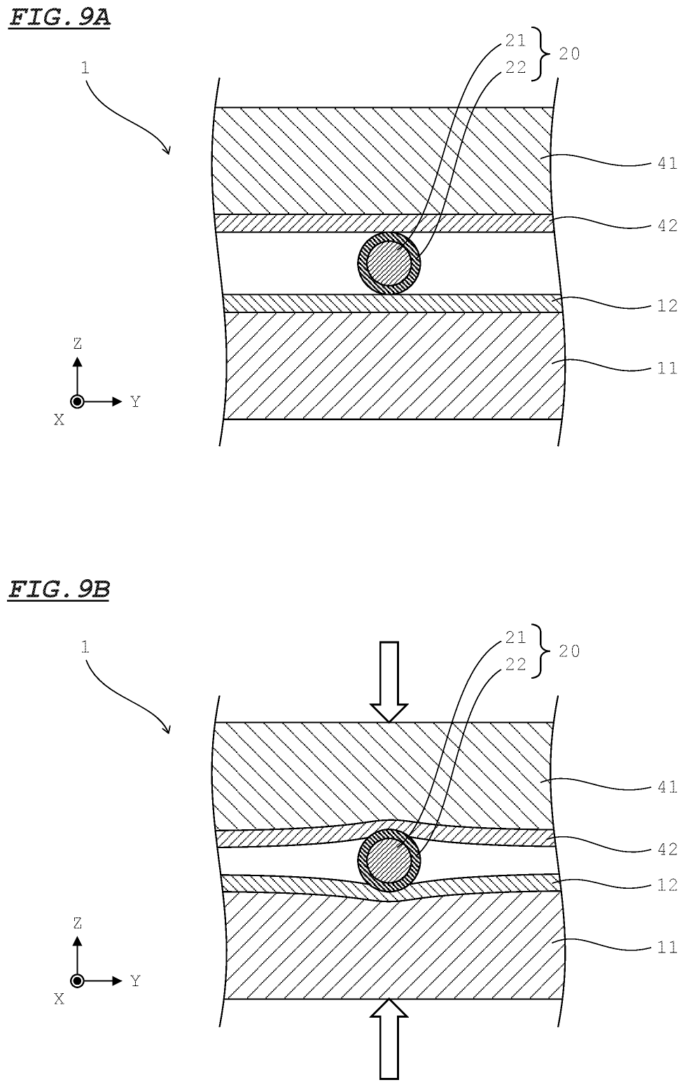

FIGS. 9A, 9B are each a cross-sectional view schematically showing the surrounding of the conductor wire 20 when the load sensor 1 in FIG. 8 is viewed in the X-axis negative direction. FIG. 9A shows a state where no load is applied, and FIG. 9B shows a state where loads are applied.

As shown in FIG. 9B, in the load sensor 1 of Embodiment 2, when loads are applied to the lower face of the base member 11 and the upper face the base member 41, the electrically-conductive elastic body 42 is deformed together with the electrically-conductive elastic body 12, by the conductor wire 20.

At this time, the conductor wire 20 is brought close to the electrically-conductive elastic bodies 12, 42 so as to be wrapped by the electrically-conductive elastic bodies 12, 42, and the contact areas between the conductor wire 20 and the electrically-conductive elastic bodies 12, 42 increase. Accordingly, the capacitance between the electrically-conductive member 21 and the electrically-conductive elastic bodies 12, 42 changes. This change in the capacitance is detected, whereby the load is calculated.

### Effects of Embodiment 2

As shown in FIG. 7A to FIG. 9B, the load sensor 1 according to Embodiment 2 includes: another base member 41 disposed so as to oppose the upper face 11a of the base member 11; a plurality of the electrically-conductive elastic bodies 42 (other electrically-conductive elastic bodies) disposed on the lower face 41a of the other base member 41 so as to respectively oppose a plurality of the electrically-conductive elastic bodies 12; and the dielectric body 22 disposed between the plurality of the electrically-conductive elastic bodies 42 (the other electrically-conductive elastic bodies) and a plurality of the electrically-conductive members 21.

With this configuration, as shown in FIG. 9B, not only the contact area between the conductor wire 20 and the electrically-conductive elastic body 12, but also the contact area between the conductor wire 20 and the electrically-conductive elastic body 42 changes in accordance with the loads. Therefore, as compared with the cases in FIGS. 3A, 3B, change in the contact area during load application is large. Therefore, the load detection sensitivity of the load sensor 1 can be increased.

In this configuration as well, similar to Embodiment 1 above, the size in the Y-axis direction of the load sensor 1 can be reduced, and the dead zone that is caused in the outer peripheral portion of the load sensor 1 can be reduced.

### Embodiment 3

In Embodiment 2 above, the wires 43 and the electrodes 32 are joined to each other, whereby the electrically-conductive elastic bodies 42 on the base member 41 side are connected to the circuit board 31. In contrast to this, in Embodiment 3, the wires 43 and the insulators 44 on the base member 41 side are omitted.

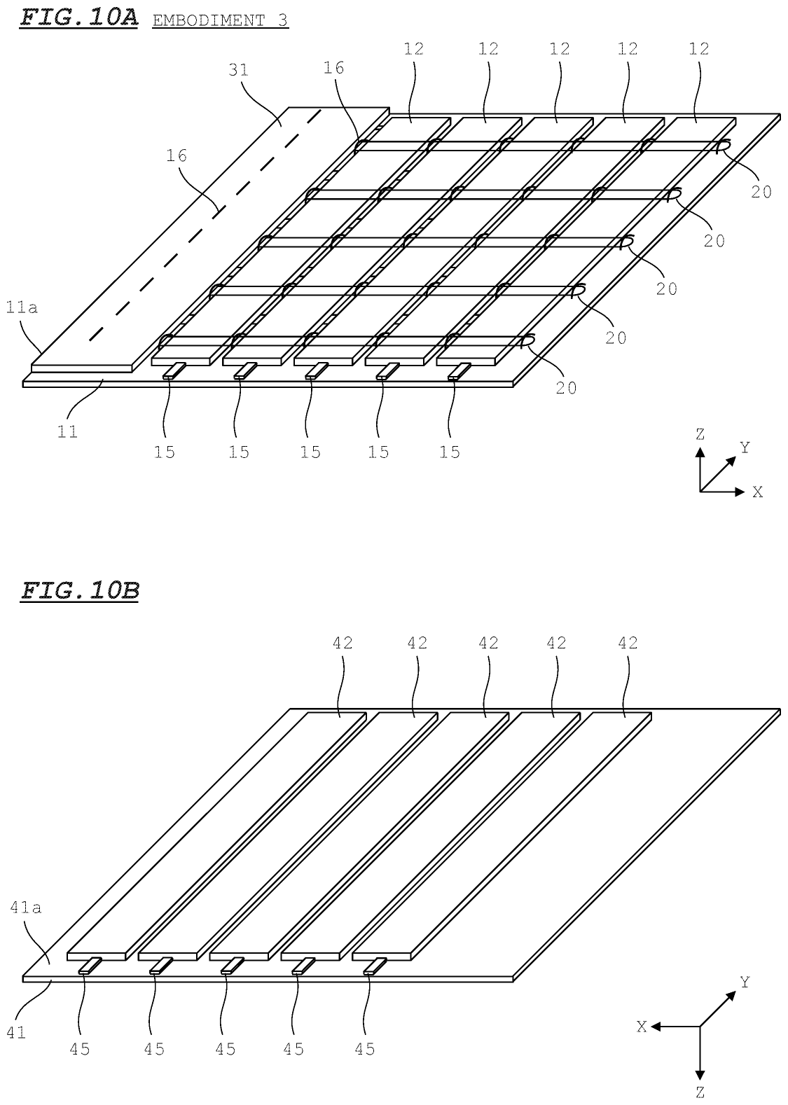

FIG. 10A is a perspective view showing the configuration of a structure according to Embodiment 3.

In the structure in FIG. 10A, end portions on the Y-axis negative side of the electric conductors 15 protrude in the Y-axis negative direction from the edges on the Y-axis negative side of the electrically-conductive elastic bodies 12. The other configurations of the structure in FIG. 10A are similar to those of the structure in FIG. 2A. In the structure in FIG. 10A, the electrodes 32 (see FIG. 7A) are not disposed on the upper face of the circuit board 31.

FIG. 10B is a perspective view showing the structure of the lower face 41a of the base member 41, according to Embodiment 3.

In Embodiment 3, the wires 43 and the insulators 44 are not formed on the lower face 41a of the base member 41. That is, in Embodiment 3, the wires 43 and the insulators 44 are omitted from the configuration in FIG. 7B. In Embodiment 3, end portions on the Y-axis negative side of the electric conductors 45 protrude in the Y-axis negative direction from the edges on the Y-axis negative side of the electrically-conductive elastic bodies 42.

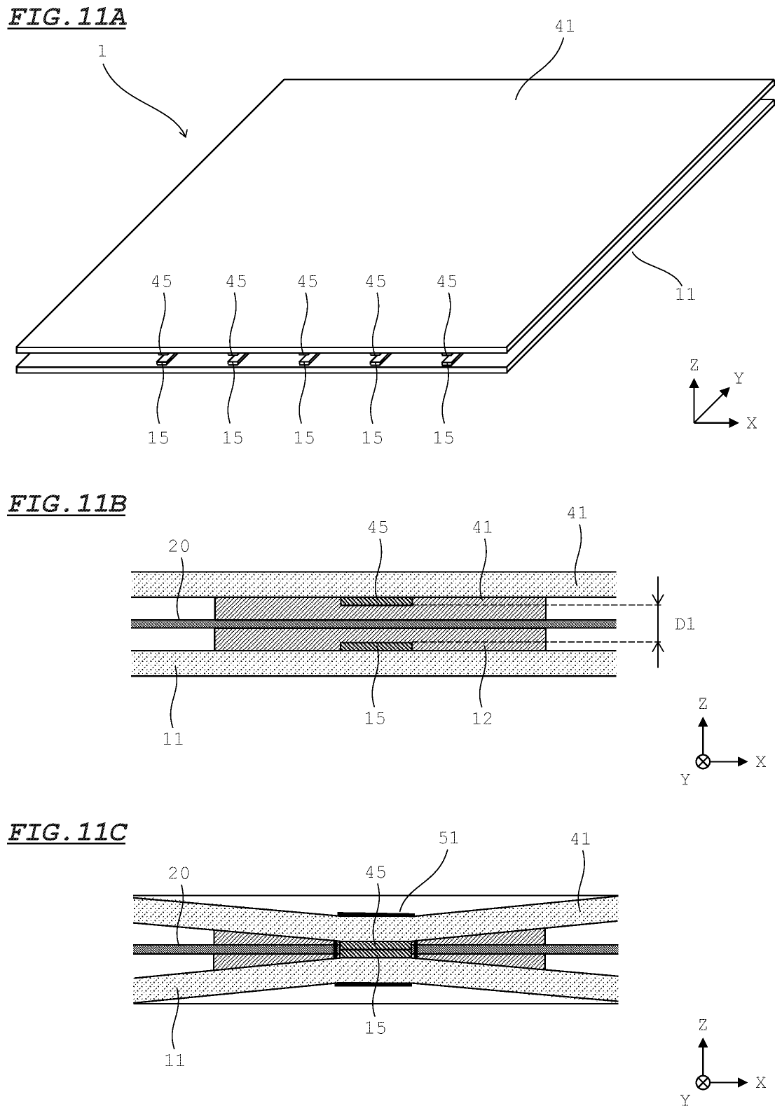

FIG. 11A is a perspective view showing a state where the structure in FIG. 10B is superposed, upside down, on the structure in FIG. 10A.

Similar to Embodiment 2 above, in the state in FIG. 11A, the five electrically-conductive elastic bodies 42 on the base member 41 side respectively oppose the five electrically-conductive elastic bodies 12 on the base member 11 side, and the five conductor wires 20 are sandwiched by the five electrically-conductive elastic bodies 42 and the five electrically-conductive elastic bodies 12. In addition, the end portions on the Y-axis negative side of the electric conductors 15 on the base member 11 side and the end portions on the Y-axis negative side of the electric conductors 45 on the base member 41 side oppose each other in the Z-axis direction.

FIG. 11B is an enlarged side view showing the end portions of the electric conductors 15, 45 opposing each other.

In FIG. 11B, for convenience, a separation distance D1 between the end portions of the electric conductors 15, 45 is shown larger than the actual distance. In actuality, the thicknesses of the electrically-conductive elastic bodies 12, 42 are small, and the separation distance D1 is very small.

In the state in FIG. 11B, the opposing positions, of the electric conductors 15, 45, at the end portions on the Y-axis negative side of the base members 11, 41 are tightly sewn by a thread 51. Accordingly, as shown in FIG. 11C, at this sewing position, the base members 11, 41 come close to each other, and the electric conductors 15, 45 are joined to each other. As a result of the joining of the electric conductors 15, 45, the electric conductors 45 on the base member 41 side and the electric conductors 15 on the base member 11 side are electrically connected to each other. Accordingly, the electric conductors 45 on the base member 41 side are connected to the circuit board 31 via the electric conductors 15 and the wires 13 on the base member 11 side.

### Effects of Embodiment 3

In the configuration of Embodiment 3 as well, similar to Embodiment 1, change in the contact area during load application becomes large, as compared with the cases in FIGS. 3A, 3B. Therefore, the load detection sensitivity of the load sensor 1 can be increased.

In this configuration as well, similar to Embodiment 1 above, the size in the Y-axis direction of the load sensor 1 can be reduced, and the dead zone that is caused in the outer peripheral portion of the load sensor 1 can be reduced.

Further, the configuration in Embodiment 3 includes, as a connection structure for electrically connecting the electrically-conductive elastic bodies 12, 42 opposing each other: a structure in which the electric conductors 15, 45 are caused to protrude from the edges of the electrically-conductive elastic bodies 12, 42 and oppose each other; and a configuration for joining, by the threads 51, portions of the electric conductors 15, 45 opposing each other. Accordingly, the wires 43 and the insulators 44 can be omitted from the configuration in FIG. 7B, and thus, the configuration can be simplified and the cost can be reduced.

The connection structure for electrically connecting the electrically-conductive elastic bodies 12, 42 opposing each other is not limited thereto. For example, the electric conductors 15, 45 maybe caused to protrude from the edges of the electrically-conductive elastic bodies 12, 42 and these protruding portions may be joined with solder.

### Modification

In Embodiments 1 to 3 above, the dielectric body 22 is set so as to cover the entire periphery of the electrically-conductive member 21. However, the dielectric body 22 maybe disposed so as to cover only at least a range, out of the surface of the electrically-conductive member 21, in which the contact area changes in accordance with the load. In addition, although the dielectric body 22 is formed from one type of material in the thickness direction, the dielectric body 22 may have a structure in which two types or more of materials are stacked in the thickness direction.

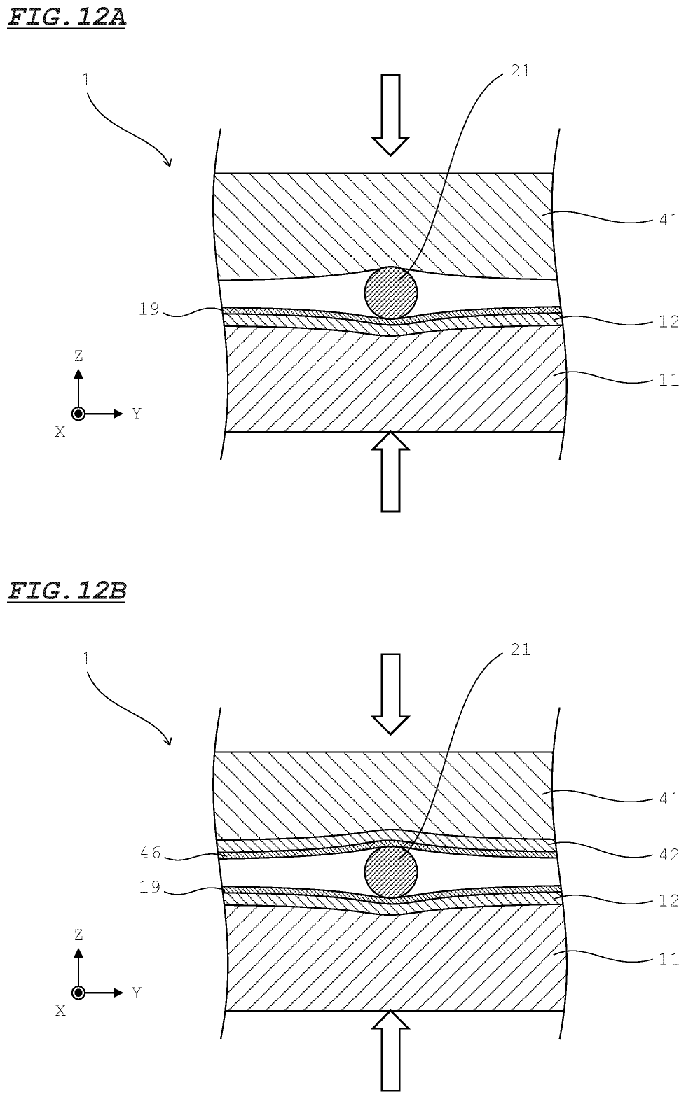

In Embodiments 1 to 3 above, the dielectric body 22 is disposed on the surface of the electrically-conductive member 21. However, a dielectric body may be disposed on the surfaces of the electrically-conductive elastic bodies 12, 42. For example, in the configuration of Embodiment 1, a dielectric body 19 maybe formed on the surface of the electrically-conductive elastic body 12 as shown in FIG. 12A. Further, in the configurations of Embodiments 2, 3, dielectric bodies 19, 46 may be respectively disposed on the surfaces of the electrically-conductive elastic bodies 12, 42 as shown in FIG. 12B. In these cases, the dielectric bodies 19, 46 can be formed from an elastically deformable material such that the contact area with the electrically-conductive member 21 changes in accordance with the loads. For example, the dielectric bodies 19, 46 are formed from a material having an elastic modulus similar to that of the electrically-conductive elastic bodies 12, 42.

In Embodiments 1 to 3 above, the cross-sectional shape of the electrically-conductive member 21 is a circle, but the cross-sectional shape of the electrically-conductive member 21 is not limited to a circle, and may be another shape such as an ellipse or a pseudo circle.

In Embodiments 1 to 3 above, as shown in FIG. 1B, the five electrically-conductive elastic bodies 12, 42 and the five conductor wires 20 (the electrically-conductive members 21) are disposed in the load sensor 1. However, the numbers of the electrically-conductive elastic bodies 12, 42 and the conductor wires 20 (the electrically-conductive members 21) disposed in the load sensor 1 are not limited thereto. For example, when the electrically-conductive elastic bodies 12 are disposed only on the base member 11 side as in Embodiment 1, a plurality of the electrically-conductive elastic bodies 12 maybe disposed and at least one conductor wire 20 (the electrically-conductive member 21) may be disposed.

For example, the load sensor 1 maybe configured such that one conductor wire 20 is superposed on two electrically-conductive elastic bodies 12. In this case as well, in a plan view, the conductor wire 20 maybe disposed at a position where the conductor wire 20 does not overlap with two wires 13 respectively connected to the two electrically-conductive elastic bodies 12, and preferably, may be disposed at a middle position of the gap between these two wires 13.

In Embodiments 1 to 3 above, each conductor wire 20 is bent at a middle position. However, the conductor wire 20 need not necessarily be bent, and two conductor wires may be connected on the circuit board 31 to form a set. Further, one set need not necessarily be composed of two conductor wires. For example, three or more conductor wires may be connected on the circuit board 31 to form a set. Alternatively, only one conductor wire may be disposed at the position of the conductor wire 20 shown in Embodiments 1, 2. In a plan view, the shape of the conductor wire 20 need not necessarily be a straight line shape, and may be a wave shape.

In Embodiments 1 to 3 above, the conductor wire 20 (the electrically-conductive member 21) is disposed at a middle position between adjacent wires 13. However, in a plan view, the conductor wire 20 (the electrically-conductive member 21) may be disposed at another position as long as the conductor wire 20 does not overlap with any wire 13. For example, the wire 13 may be disposed between (between a straight line portion extending in the X-axis direction) one conductor wire 20 (the electrically-conductive member 21) bent in a U-shape.

In Embodiment 1 above, as shown in FIGS. 4A to 4D, the insulator 14 is disposed not only in the range where the wire 13 and the electrically-conductive elastic body 12 overlap each other, but also in the range (the range of the gap between adjacent electrically-conductive elastic bodies 12) where the wire 13 and the electrically-conductive elastic body 12 do not overlap each other. However, the insulator 14 need not necessarily be disposed in the range where the wire 13 and the electrically-conductive elastic body 12 do not overlap each other. This also applies to Embodiments 2, 3.

In Embodiment 1 above, as shown in FIGS. 4A to 4D, the lengths of the electric conductors 15 are the same. However, the lengths of the electric conductors 15 maybe different from each other. The width in the x-axis direction of each electric conductor 15 is not limited to the width shown in Embodiments 1 to 3 above. For example, the width in the x-axis direction of the electric conductor 15 maybe substantially the same as the width of the electrically-conductive elastic body 12. Further, if no problem is caused in the load detection, the electric conductor 15 need not necessarily have elasticity. These also apply to the electric conductor 45.

If the resistance value of the electrically-conductive elastic body 12 does not cause any problem in the load detection, the electric conductor 15 maybe omitted, and the wire 13 maybe connected only to the electrically-conductive elastic body 12. This also applies to Embodiments 2, 3.

The method for disposing the electrically-conductive elastic bodies 12, the wires 13, the insulators 14, and the electric conductors 15 on the upper face 11a of the base member 11 is not necessarily limited to printing. Another method such as a method of adhering a foil may be adopted. Further, a plurality of the wires 13, 43 maybe connected to one electrically-conductive elastic body 12, 42. Further, the first direction and the second direction need not necessarily be perpendicular to each other.

In addition to the above, various modifications can be made as appropriate to the embodiments of the present invention without departing from the scope of the technical idea defined by the claims.

What is claimed is:

1. A load sensor comprising:
a base member having a flat plate shape;
a plurality of electrically-conductive elastic bodies disposed so as to extend in a first direction on an upper face of the base member;
at least one electrically-conductive member extending in a second direction and crossing the plurality of electrically-conductive elastic bodies;
a dielectric body disposed between the plurality of electrically-conductive elastic bodies and the electrically-conductive member; and
a plurality of wires respectively connected to the plurality of electrically-conductive elastic bodies and disposed so as to extend in the second direction on the upper face of the base member, wherein
each wire
is disposed at a position where the wire does not overlap with the electrically-conductive member, and
is insulated at least in a range where the wire overlaps with the electrically-conductive elastic body other than the electrically-conductive elastic body serving as a connection target.

2. The load sensor according to claim 1, wherein
a plurality of electric conductors having a resistance lower than that of the electrically-conductive elastic bodies are disposed on the upper face of the base member so as to be respectively covered by the plurality of electrically-conductive elastic bodies and so as to each extend in the first direction, and
the wire is connected to the electric conductor that is at a position of the electrically-conductive elastic body serving as the connection target.

3. The load sensor according to claim 2, wherein
the plurality of electric conductors are disposed over at least an entire range of the electrically-conductive elastic bodies in the first direction.

4. The load sensor according to claim 1, wherein
in a range between the wires adjacent to each other, the electrically-conductive member is disposed.

5. The load sensor according to claim 1, wherein
each electrically-conductive elastic body and each wire are formed on the upper face of the base member by printing.

6. The load sensor according to claim 1, wherein
the dielectric body is set so as to cover a surface of the electrically-conductive member.

7. The load sensor according to claim 1, comprising:
another base member disposed so as to oppose the upper face of the base member;
a plurality of other electrically-conductive elastic bodies disposed on a lower face of the other base member so as to respectively oppose the plurality of electrically-conductive elastic bodies; and
a dielectric body disposed between the plurality of other electrically-conductive elastic bodies and the electrically-conductive member.

8. The load sensor according to claim 7, comprising
a connection structure configured to electrically connect the electrically-conductive elastic bodies and the other electrically-conductive elastic bodies opposing each other.
